(19) United States
(12) Patent Application Publication
(10) Pub. No.: US 2024/0142944 A1
(43) Pub. Date: May 2, 2024

(54) METHODS AND INTERNET OF THINGS SYSTEMS FOR NOISE CONTROL BASED ON SMART GAS PLATFORMS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Guanghua HUANG, Chengdu (CN)

(73) Assignee: CHENGDU QINCHUAN IOT TECHNOLOGY CO., LTD., Chengdu, Sichuan (CN)

(21) Appl. No.: 18/411,059

(22) Filed: Jan. 12, 2024

(30) Foreign Application Priority Data
Dec. 20, 2023 (CN) 202311770284.8

(51) Int. Cl. G05B 19/4155

(52) U.S. Cl. CPC G05B 19/4155; G05B 2219/41108

(57) ABSTRACT

The present disclosure provides a method for noise control based on a smart gas platform, wherein the method is executed by a smart gas safety management platform of an Internet of Things (IoT) system for noise control based on the smart gas platform, comprising: obtaining noise data of a gas field station through a sound sensor, the sound sensor being arranged at least one monitoring position of the gas field station, and any one monitoring position having a corresponding monitoring period; determining noise change features of the at least one monitoring position based on the noise data; and determining target operating parameters of the gas field station based on the noise change features, the target operating parameters including a target gas flow rate of a gas pipeline in the gas field station.

### CROSS-REFERENCE TO RELATED APPLICATIONS

This application claims priority to Chinese Patent Application No. CN202311770284.8, filed on Dec. 20, 2023, the entire contents of which are hereby incorporated by reference.

### TECHNICAL FIELD

The present disclosure relates to the technical field of gas equipment, and in particular relates to a method and an Internet of Things system for noise control based on a smart gas platform.

### BACKGROUND

Noise from a gas field station is a major health hazard to staff and those around the gas field station. The noise in the gas field station mainly comes from the friction and collision between a high-speed flowing gas in a pipeline and an inner wall of the pipeline, and the faster a gas flow rate is, the greater the noise generated in the pipeline is. Noise reduction of the gas field station of the existing technology is mostly focused on the laying of acoustic sound-deadening materials, set up noise-reducing pipelines, etc. The existing technology often may not be adapted to the complexity and variability of the gas transmission environment, when a wall of a gas transmission pipeline adheres to more impurities with the prolongation of the transmission time, more serious noise pollution problems are often caused, which seriously affects the physical and mental health of the surrounding staff and residents.

The patent application with Publication No. CN115240627A provides a noise reduction method, a device, and a storage medium for a gas pressure regulating device. The application provides a technical solution that actively eliminates noise by filtering, adding sound signal active intervention, etc. to achieve noise reduction. However, the application is only capable of reducing the noise that has already been generated, but not reducing the generation of noise, and has not solved the problem fundamentally.

Therefore, it is desired to provide a method and an Internet of Things system for noise control based on a smart gas platform, which may be used to control the noise generated during the operation of a gas pipeline network in conjunction with a noise pollution situation in a targeted manner in terms of the causes of the noise.

### SUMMARY

One or more embodiments of the present disclosure provide a method for noise control based on a smart gas service platform. The method comprises obtaining noise data of a gas field station through a sound sensor, the sound sensor being arranged at least one monitoring position of the gas field station, and any one monitoring position having a corresponding monitoring period; determining noise change features of the at least one monitoring position, based on the noise data; and determining target operating parameters of the gas field station, based on the noise change features, the target operating parameters including a target gas flow rate of a gas pipeline in the gas field station.

One or more embodiments of the present disclosure provide an Internet of Things (IoT) system for noise control based on a smart gas platform. The IoT system includes a smart gas user platform, a smart gas service platform, a smart gas safety management platform, a smart gas pipeline network equipment sensor network platform, and a smart gas pipeline network equipment object platform; the smart gas safety management platform being configured to: obtain noise data of a gas field station through a sound sensor, the sound sensor being arranged at least one monitoring position of the gas field station, and any one monitoring position having a corresponding monitoring period; determine noise change features of the at least one monitoring position, based on the noise data; and determine target operating parameters of the gas field station, based on the noise change features, the target operating parameters including a target gas flow rate of a gas pipeline in the gas field station.

One or more embodiments of the present disclosure provide a non-transitory computer-readable storage medium, comprising a set of instructions, wherein when a computer reads the computer instructions in the storage medium, the method for noise control based on a smart gas platform.

### BRIEF DESCRIPTION OF THE DRAWINGS

FIG. 1 is a platform structure diagram illustrating an IoT system for noise control based on a smart gas platform according to some embodiments of the present disclosure;

FIG. 2 is an exemplary flowchart illustrating a method for noise control based on a smart gas platform according to some embodiments of the present disclosure;

FIG. 3 is an exemplary schematic diagram illustrating a process for determining target operating parameters according to some embodiments of the present disclosure;

FIG. 4 is an exemplary schematic diagram illustrating a process for determining a cleaning cycle according to some embodiments of the present disclosure;

FIG. 5 is a schematic diagram illustrating a process for assessing a rate of impurity accumulation of a gas pipeline according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels. However, the terms may be displaced by another expression if they achieve the same purpose.

The flowcharts used in the present disclosure illustrate operations that systems implement according to some embodiments of the present disclosure. It is to be expressly understood the operations of the flowcharts may be implemented not in order. Conversely, the operations may be implemented in an inverted order, or simultaneously. Moreover, one or more other operations may be added to the flowcharts. One or more operations may be removed from the flowcharts.

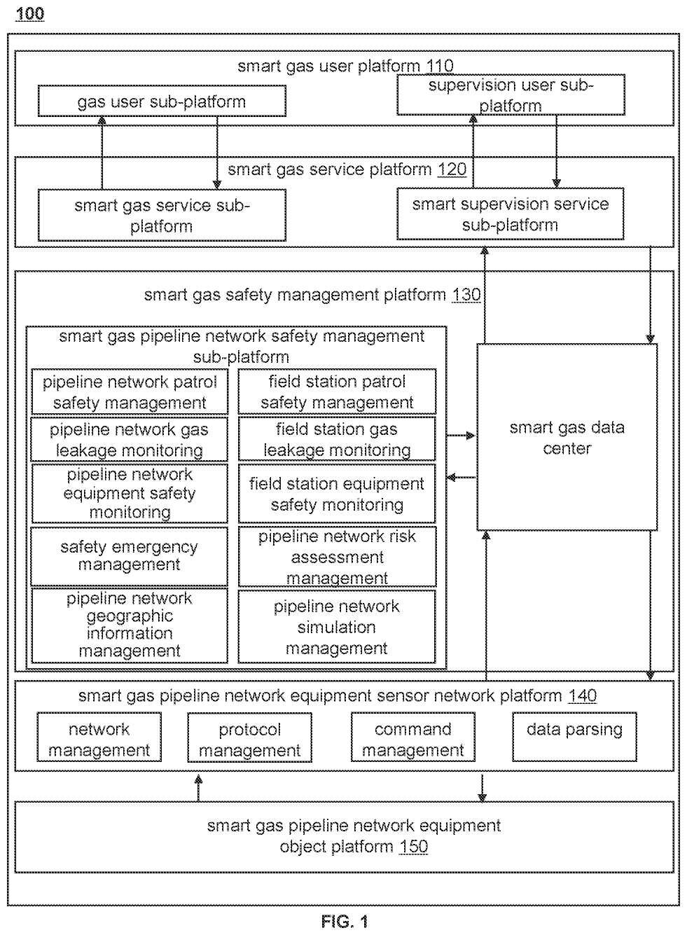

FIG. 1 is a platform structure diagram illustrating an IoT system for noise control based on a smart gas platform according to some embodiments of the present disclosure.

As shown in FIG. 1, in some embodiments, an IoT system 100 for noise control based on a smart gas platform may include a smart gas user platform 110, a smart gas service platform 120, a smart gas safety management platform 130, a smart gas pipeline network equipment sensor network platform 140, and a smart gas pipeline network equipment object platform 150.

The smart gas user platform refers to a platform used to interact with users. The smart gas user platform may be configured as a terminal device.

In some embodiments, the smart gas user platform may include a gas user sub-platform and a regulatory user sub-platform. The gas user sub-platform may be used for gas users. The regulatory user sub-platform may be used for regulating the user, such as relevant personnel and/or departments concerned with safeguarding gas safety.

The smart gas service platform may be a platform for receiving and transmitting data and/or information. For example, the smart gas service platform may receive an instruction sent by the smart gas user platform and process and send the instruction to the smart gas safety management platform. As another example, information required by the user is obtained from the smart gas safety management platform and sent to the smart gas user platform.

In some embodiments, the smart gas service platform may include a smart gas service sub-platform and a smart supervision service sub-platform. The smart gas service sub-platform may interact with the gas user sub-platform correspondingly. The smart supervision service sub-platform may interact with the regulatory user sub-platform correspondingly.

The smart gas safety management platform may be a platform that provides sensing management and control management functions for the IoT system for noise control based on a smart gas platform. The smart gas safety management platform may coordinate and harmonize the linkage and collaboration between functional platforms, and converge all of information of the IoT system for noise control based on the smart gas platform.

In some embodiments, the smart gas safety management platform may include a smart gas data center and a smart gas pipeline network safety management sub-platform. The smart gas data center may aggregate and store all operational data of a gas field station's noise reduction IoT system. The smart gas safety management platform may exchange information with the smart gas service platform and the smart gas pipeline network equipment sensor network platform through the smart gas data center.

The smart gas pipeline network safety management sub-platform may be a separate data usage platform. The smart gas pipeline network safety management sub-platform may obtain relevant data from the smart gas data center and send operational data for management operations to the smart gas data center. In some embodiments, the smart gas pipeline network safety management sub-platform may include pipeline network patrol safety management, pipeline network gas leakage monitoring, pipeline network equipment safety monitoring, safety emergency response management, pipeline network geographic information management, field station patrol safety management, field station gas leakage monitoring, field station equipment safety monitoring, pipeline network risk assessment management, pipeline network simulation management, etc.

Exemplarily, the smart gas data center may receive an operation and management information query instruction of the gas gate station issued by the smart gas service platform. The smart gas data center may send an instruction to obtain relevant data of gas equipment (e.g., noise data) to the smart gas pipeline network equipment sensor network platform, or receive uploaded data of gas equipment from the smart gas pipeline network equipment sensor network platform. The smart gas data center sends the collected data of the gas equipment to the smart gas management sub-platform for analysis and processing.

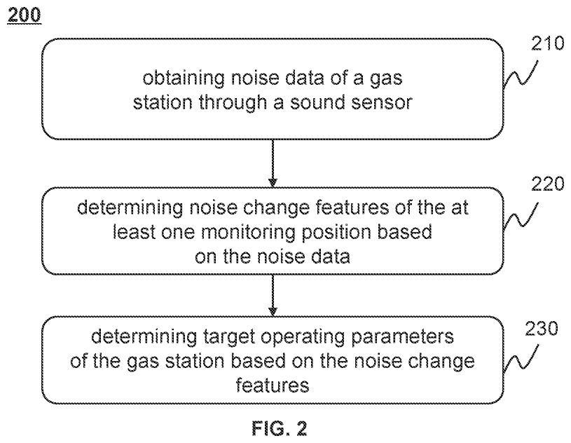

For more information on the smart gas safety management platform and its functions, please refer to FIGS. 2 to 5 and its related description of the present disclosure.

The smart gas pipeline network equipment sensor network platform refers to a functional platform for managing sensing communications. In some embodiments, the smart gas pipeline network equipment sensor network platform may be configured as a communication network and a gateway. The smart gas pipeline network equipment sensor network platform may receive relevant data uploaded by the object platform and issue an instruction to obtain relevant data to the smart gas pipeline network equipment object platform. Alternatively, the smart gas pipeline network equipment sensor network platform may receive the instruction to obtain the relevant data issued by the smart gas data center and upload relevant data to the smart gas data center. In some embodiments, the smart gas pipeline network equipment sensor network platform is configured to interact with the smart gas data center and the smart gas pipeline network equipment object platform.

In some embodiments, the smart gas pipeline network equipment sensor network platform may achieve one or more functions such as network management, protocol management, command management, and data parsing.

The smart gas pipeline network equipment object platform refers to a functional platform for sensing information generation. The smart gas pipeline network equipment object platform may be configured as various types of gas-related equipment. The gas-related equipment may include pipeline network equipment. The pipeline network equipment may include gas gate stations, various sections of gas pipelines, gas valve control equipment, gas meters, flow meters, manometers, sound sensors, pressure regulating equipment, temperature sensors, humidity sensors, or the like. The information that may be acquired by the smart gas pipeline network equipment object platform includes, but is not limited to, gas flow information, gas pressure information, etc., and the collected information may be transmitted through the smart gas pipeline network equipment sensor network platform to the smart gas safety management platform.

The present disclosure relates to the IoT system for noise control based on the smart gas platform, which may form a closed loop of information operation between the smart gas pipeline network equipment object platform and the smart gas user platform. The system is coordinated and operated in a regular manner under the unified management of the smart gas safety management platform, thereby achieving the informatization and smart of the gas field station noise reduction.

FIG. 2 is an exemplary flowchart illustrating a method for noise control based on a smart gas platform according to some embodiments of the present disclosure. In some embodiments, a process 200 may be executed by the smart gas safety management platform of the Internet of Things (IoT) system for noise control based on the smart gas platform. As shown in FIG. 2, the process 200 includes the following steps.
Step 210, obtaining noise data of a gas field station through a sound sensor.

The sound sensor refers to a device used to capture a sound generated by the gas field station. In some embodiments, the sound sensor may be arranged at least one monitoring position of the gas field station.

The noise data refers to data related to the noise generated during the operation of the gas field station.

In some embodiments, the noise data includes at least noise intensity data and noise frequency data.

The noise intensity data represents the strength of the noise, with a higher value indicating a louder sound.

The noise frequency data characterizes the pitch of the noise, wherein high-frequency noise energy decays rapidly and is easily isolated, while low-frequency noise energy decays slowly and is not easily isolated.

In some embodiments, the smart gas safety management platform may obtain the noise data from the sound sensor configured by the smart gas pipeline network equipment object platform based on the smart gas pipeline network equipment sensor network platform.
Step 220, determining noise change features of the at least one monitoring position based on the noise data.

The monitoring position refers to a position where the noise data needs to be monitored. For example, the monitoring position may be a position near the pressure regulating equipment within the gas field station, a position where a major gas pipeline is located, a position near an office within the gas field station, and so on.

In some embodiments, each monitoring position has a corresponding monitoring period. For example, the monitoring period corresponding to the position near a residential neighborhood is primarily the time period when the residents are resting, and the monitoring period corresponding to the position near the office within the gas field station is primarily the time period when the office is working.

The monitoring period refers to the time period for which the noise data is required. For example, the monitoring period may be a time period when the residents are resting, a time period when they are working, etc.

The noise change features are change features of the noise data over a certain period of time.

In some embodiments, the noise change features may include at least an intensity change feature and a frequency change feature.

The intensity change feature refers to a change feature of the noise over a certain period of time. For example, the intensity change feature may include a sound intensity fluctuation amplitude, a sound intensity fluctuation time interval, a sound intensity change trend, a sound intensity change rate, etc., for the same time period of each day for a certain period of time. The sound intensity trend may include a general change in noise intensity being louder or smaller over a certain period of time.

The frequency change feature refers to a frequency change feature of the noise over a certain period of time. For example, the frequency change feature may include a frequency fluctuation amplitude, a frequency fluctuation interval, a frequency change trend, a frequency change rate, or the like, for the same time period every day for a certain period of time. The frequency change trend refers to the total change of the noise frequency within the time period to become larger or smaller.

In some embodiments, the noise change feature may be represented as a vector. For example, the noise change feature may be represented as [(a, b, c, d), (e, f, g, h)]. (a, b, c, d) represents the intensity change feature, with a representing the sound intensity fluctuation amplitude, b representing the sound intensity fluctuation time interval, c representing the sound intensity change trend, and d representing the sound intensity fluctuation change rate; (e, f, g, h) represents the frequency change feature, with e representing the frequency fluctuation amplitude, f representing the frequency fluctuation time interval, g representing the frequency change trend, and h representing the frequency change rate.

In some embodiments, the smart gas safety management sub-platform may obtain and aggregate the noise data from the smart gas data center to determine the noise change features.
Step 230, determining target operating parameters of the gas field station based on the noise change features.

The target operating parameters refer to gas parameters related to the operation of the gas field station. In some embodiments, the target operating parameters include at least a target gas flow rate of the gas pipeline within the gas field station. The target gas flow rate refers to a flow rate of a gas pipeline to be adjusted. For more information of the gas pipeline to be adjusted, please refer to FIG. 2 and its related description of the present disclosure.

In some embodiments, the smart gas safety management platform may determine the target operating parameters based on the noise change features and send an adjustment instruction to the smart gas pipeline network equipment object platform through the smart gas pipeline network equipment sensor network platform.

In some embodiments, in response to each feature change in the noise change features of the monitoring position being greater than a preset fluctuation threshold and a time for generating the change being less than a preset time threshold, the smart gas safety management platform may adjust a target gas flow rate of a gas pipeline in the vicinity of the monitoring position, so that the noise change features of the monitoring position are stabilized. For example, when the frequency fluctuation amplitude at the monitoring position is greater than the frequency fluctuation threshold, and a time interval for such frequency change is less than the preset time threshold, the smart gas safety management platform may adjust the target gas flow rate of the gas pipeline near the monitoring position to a stable rate in order to avoid noise generated by an unstable gas flow rate.

In some embodiments, the smart gas safety management platform may determine the gas pipeline to be adjusted based on the noise change features at the monitoring position, determine a flow rate adjustment amplitude of the gas pipeline to be adjusted, and establish the target operating parameters of the gas pipeline based on the aforementioned flow rate adjustment amplitude.

For more information about adjusting the target operating parameters, please refer to FIG. 2 and its related description.

In some embodiments of the present disclosure, the noise change features are determined by obtaining the noise data from different monitoring positions at different monitoring periods, thereby determining the target operating parameters and adjusting them, which may adjust the gas pipeline in combination with noise pollution in different environments and reduce the impact of the noise on the people around the gas pipeline.

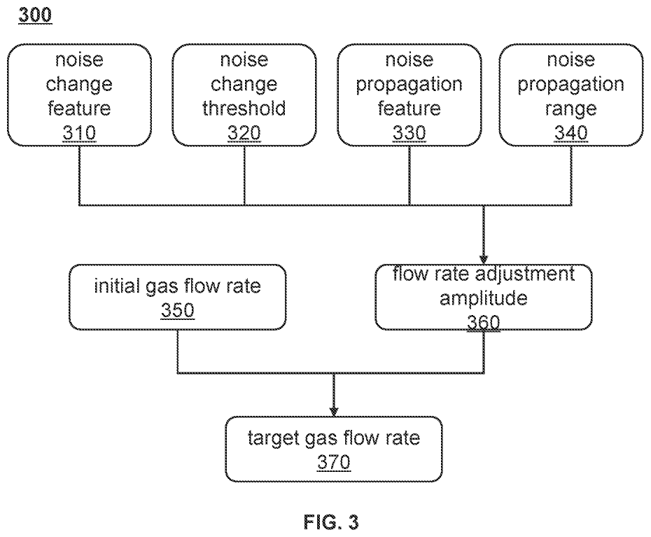

FIG. 3 is an exemplary schematic diagram for determining target operating parameters according to some embodiments of the present disclosure. As shown in FIG. 3, a process 300 for determining the target operating parameters may include the following steps.

In some embodiments, in response to the noise change features of the monitoring position meeting a first preset condition, the smart gas safety management platform may determine the aforesaid monitoring position as a target monitoring position.

The target monitoring position refers to a monitoring position that needs to be focused on its noise condition.

In some embodiments, the smart gas safety management platform may determine whether the noise change features meet the first preset condition.

In some embodiments, the first preset condition may include a noise change threshold. The noise change threshold may include an intensity change threshold and a frequency change threshold. The intensity change threshold refers to a maximum value allowed for the intensity change feature, and the frequency change threshold refers to a maximum value allowed for the frequency change feature.

When a value of any noise change feature at the monitoring position exceeds its corresponding threshold, it indicates that the gas flow rate at the monitoring position is unstable and its operating parameters need to be adjusted.

In some embodiments, the smart gas safety management platform may determine the gas pipeline to be adjusted based on noise propagation features between the target monitoring position and the gas pipeline; determine the flow rate adjustment amplitude of the gas pipeline based on the noise change features, the noise change threshold, the noise propagation features, and a noise propagation range; determine the flow rate adjustment amplitude of the gas pipeline to be adjusted; and based on an initial gas flow rate of the gas pipeline to be adjusted and the flow rate adjustment amplitude, determine the target gas flow rate of the gas pipeline.

The noise propagation features refer to features associated with noise propagation. For example, the noise propagation feature may include a distance that the noise travels from its source to the monitoring position, a density of obstacles along the propagation route, etc. The aforementioned distance and the density of obstacles may be determined based on geographic information of a region where the gas pipeline network is located.

The noise propagation range refers to a limit of noise propagation range. When the noise travels beyond the noise propagation range, it may be assumed that the noise does not have an adverse impact at that point.

The pipeline to be adjusted refer to a pipeline whose operating parameters need to be adjusted. By adjusting the operating parameters of such pipeline, the noise generated during the gas transmission process may be reduced to a certain extent.

In some embodiments, the smart gas safety management platform may treat a gas pipeline whose noise propagation feature is within the noise propagation range as the gas pipeline to be adjusted. If the noise propagation feature between the monitoring position and the gas pipeline are outside the noise propagation range, it indicates that the monitoring position is far away from the gas pipeline. When the noise generated by the gas pipeline reaches the monitoring position, the noise intensity is already very low, and therefore, the gas pipeline does not need to be treated as the gas pipeline to be adjusted.

In some embodiments, the smart gas safety management platform may determine a flow rate adjustment amplitude 360 of the gas pipeline to be adjusted in a variety of ways.

In some embodiments, the smart gas safety management platform may determine the flow rate adjustment amplitude 360 of the gas pipeline to be adjusted through a preset algorithm based on noise change features 310, a noise change threshold 320, a noise propagation feature 330, and a noise propagation range 340.

In some embodiments, the preset algorithm may involve weighted calculation based on a noise change rate and a propagation variance rate to determine the flow rate adjustment amplitude. The noise change rate represents a percentage of the noise change feature at the target monitoring position exceeding the noise change threshold, and the propagation variance rate represents a percentage of a difference between the noise propagation distance and the noise propagation range relative to the noise propagation range. For example, the preset algorithm may include formula (1):

W=k₁·Δa+k₂·Δb

In the above formula, W represents the flow rate adjustment amplitude, Δa represents the noise change rate, Δb represents the propagation variance rate, and k₁ and k₂ are coefficients. k₁ and k₂ may be determined based on historical experience.

In some embodiments, the noise change features include the intensity change feature and the frequency change feature, with the intensity change feature having a greater impact on the flow rate adjustment amplitude than the frequency change feature. For example, the difference between the noise change feature and the noise change threshold may be determined by a weighted sum of the difference between the intensity change feature and the intensity change threshold, and the difference between the frequency change feature and the frequency change threshold. The weight of the former may be greater than that of the latter.

In some embodiments, the noise change rate may be determined by the weighted sum of the percentage of the intensity change feature exceeding the intensity change threshold, and the percentage of the frequency change feature exceeding the frequency change threshold. The above preset algorithm may include formula (2):

W=k₁·(α₁Δa₁+α₂Δa₂)+k₂·Δb

In the above formula, W represents the flow rate adjustment amplitude, Δa₁ represents the percentage of the intensity change feature exceeding the intensity change threshold, Δa₂ represents the percentage of the frequency change feature exceeding the frequency change threshold, and Δb represents the difference between the noise propagation distance and the noise propagation range as a percentage of the noise propagation range. k₁, k₂, α₁, and α₂ are coefficients. α₁>α₂, and k₁, k₂, α₁, and α₂ may be determined based on historical experience.

In some embodiments of the present disclosure, the impact of the intensity change feature and the frequency change feature on the adjustment of the gas flow rate is different. By determining the impact of the intensity change feature and the frequency change feature on the determination of the flow rate adjustment amplitude, the flow rate adjustment amplitude may be more reasonably determined to meet an actual demand, thus better adjusting the noise generated during the operation of the gas pipeline network.

In some embodiments, the smart gas safety management platform may further predict estimated change features corresponding to the flow rate adjustment amplitude by a noise prediction model, based on a station feature map; and determine a preferred adjustment amplitude by iteratively updating the flow rate adjustment amplitude based on the estimated change features.

The station feature map refers to a network diagram that characterizes a gas network.

In some embodiments, the station feature map may include nodes and edges.

The nodes may represent at least one of the gas field station regulating equipment, a gas pipeline branch point, and a monitoring position. The gas field station regulating equipment is a node with a class I, and node feature of the node with the class I includes an equipment type and equipment operation parameters of the gas field station regulating equipment; the gas pipeline branch point is a node with a class II, and node feature of the node with the class II includes a number of branches at the branch point of the gas pipeline; the monitoring position is a node with a class III, and node feature of the node with the class III includes a relative positional relationship between the monitoring position and the aforementioned node with the class I and the node with the class II, a monitoring time period corresponding to this monitoring position, and whether or not a target monitoring position, and the node with the class III being a dangling node without an edge connected to it.

The edges may represent the gas pipeline, and edge features may include a pipeline length, a pipeline diameter, pipeline roughness, and an adjusted gas flow rate. The adjusted gas flow rate may be determined based on an initial gas flow rate and a flow rate adjustment amplitude for a current iteration round.

In some embodiments, the edges are directed edges, and the direction of the edges may be a direction of the gas flow in the gas pipeline.

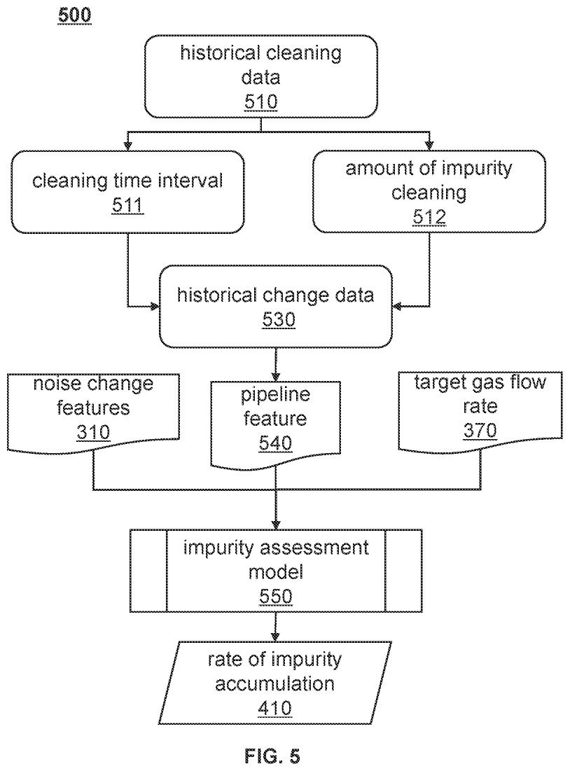

For more information about the pipeline roughness, please refer to FIG. 5 and its related description of the present disclosure. For more information about the target gas flow rate, please refer to its related description.

In some embodiments, the smart gas safety management platform may construct the station feature map based on pipeline data, pressure regulating equipment data, initial gas flow rate, and the flow rate adjustment amplitude of a target gas field station.

In some embodiments, the smart gas safety management platform may predict the estimated change features based on the station feature map via the noise prediction model. The estimated change features refer to noise change features after adjusting the gas flow rate based on the flow rate adjustment amplitude.

In some embodiments, the noise prediction model may be a machine learning model. For example, a graph neural network model (GNN), or the like.

In some embodiments, inputs to the noise prediction model may include the station feature map, and outputs of the noise prediction model may be the estimated change features of at least one monitoring position during its corresponding monitoring period. The estimated change features may be represented as a vector in a form similar to the noise change features, and for more information, please refer to FIG. 2 and its related description.

In some embodiments, the smart gas safety management platform may train an initial noise prediction model based on a plurality of first training samples with first labels. For example, the plurality of first training samples may be input into the initial noise prediction model, and a loss function may be constructed based on the output of the initial noise prediction model with the first labels; based on the loss function, parameters of the initial noise prediction model may be updated by a gradient descent method, or by other feasible methods, until an end-of-training condition is reached, and a trained noise prediction model is obtained. The end-of-training condition may include a loss function convergence, a number of iterations reaching a threshold, and so on.

In some embodiments, the first training samples may include a sample gas field station feature map constructed based on the historical data, which is constructed in a manner similar to the manner in which the gas field station feature map is constructed, as discussed in the preceding description.

The first labels may be historical noise change features in the historical data corresponding to the sample station feature map. In some embodiments, the first labels may be determined based on an analysis of the historical noise data.

In some embodiments, the smart gas safety management platform may iteratively update the flow rate adjustment amplitude based on the estimated change features and determine the preferred adjustment amplitude based on the iterative update.

For each round of iterative update, the smart gas safety management platform may update the features of the station feature map in the current round based on the estimated change features output from the previous iteration round. For example, the monitoring position at which the estimated change features exceeds the noise change threshold is determined as the target monitoring position for the current iteration round, and node features of three types of nodes are updated based on the aforementioned target monitoring position. The preset algorithm is used to determine the flow rate adjustment amplitude for the current iteration round. The flow rate adjustment amplitude is determined in the current iteration round based on the aforementioned flow rate adjustment amplitude. The station feature map is updated based on the aforementioned adjusted gas flow rate. Based on a new station feature map, new estimated change features are predicted through the noise prediction model until the estimated change features output from the noise prediction model are less than the noise change threshold, the iteration ends, and the flow rate adjustment amplitude in the iteration round is taken as a prioritized adjustment amplitude.

In some embodiments, for each round of iterative updates, the smart gas safety management platform may also configured to determine an output pressure of the gas pipeline after adjustment based on the flow rate adjustment amplitude by processing the flow rate adjustment amplitude through a pressure judgment model; determine the estimated change features through the noise prediction model, in response to the output pressure meeting a preset pressure condition; and re-determine the flow rate adjustment amplitude, in response to the output pressure not meeting the preset pressure condition.

In some embodiments, the preset pressure condition may include a gas supply demand. The gas supply demand refers to a pressure demand that ensures the normal use of gas users and may be determined based on gas consumption data of downstream users. The higher the gas consumption per unit time is, the higher the gas supply demand is.

When the output pressure is not less than the pressure demand corresponding to the gas supply demand, the output pressure meets the preset pressure condition. Conversely, if the output pressure is lower than the pressure demand corresponding to the gas supply demand, the preset pressure condition is not met.

When the output pressure does not meet the preset pressure condition, the smart gas safety management platform may re-determine the flow rate adjustment amplitude. For example, the flow rate adjustment amplitude may be changed in small increments to increase the overall gas flow rate in the gas pipeline, thereby increasing the output pressure in the gas pipeline.

In some embodiments, the smart gas safety management platform may determine the output pressure of the corresponding gas pipeline after adjusting the gas flow rate based on the aforementioned flow rate adjustment amplitude by means of the pressure judgment model.

In some embodiments, the pressure judgment model may be a machine learning model. For example, a deep neural network (DNN) model.

In some embodiments, inputs to the pressure judgment model may include the target gas flow rate, upstream gas data, and a field station pressure regulating path, and outputs of the pressure judgment model may be the output pressure of the gas pipeline.

The target gas flow rate refers to a gas flow rate adjusted based on the flow rate adjustment amplitude. In some embodiments, the target gas flow rate may be determined based on the initial gas flow rate and the flow rate adjustment amplitude, as described previously.

The upstream gas data refers to input characterization data of the upstream gas flow into the current gas field station, which may include a gas flow rate, a flow rate, a gas pressure, or the like. In some embodiments, the upstream gas data may be obtained based on historical data. For example, historical upstream gas data is determined based on an average of the historical upstream gas data for at least one target time period in the historical data.

The field station pressure regulating path refers to diversion and convergence paths of upstream gas after entering the current gas field station, and paths of the field station equipment that have passed through successively. In some embodiments, the field station pressure regulating path may be determined based on the field station feature map, and the field station pressure regulating path may be represented as a path sequence, each of which may include at least one node through which the gas passes in sequence and at least one gas pipeline.

In some embodiments, the smart gas safety management platform may train an initial pressure judgment model based on a plurality of second training samples with second labels, and the training process is similar to that of the noise prediction model, which may be described in the preceding relevant description.

In some embodiments, the second training samples may include a historical gas flow rate, historical upstream gas data, and a historical field station pressure regulating path corresponding to at least one historical time period. The second labels may include a historical output pressure corresponding to the aforementioned at least one historical time period. In some embodiments, the second labels may be obtained based on historical data.

In some embodiments of the present disclosure, determining whether the flow rate adjustment amplitude is used for the current round of iterative updating by the preset pressure condition fully takes into account the impact of the gas flow rate on the gas delivery pressure, and is able to take into account the normal supply of gas in the process of realizing noise control, which is conducive to controlling the noise while ensuring the normal use of gas users.

In some embodiments, the smart gas safety management platform may determine a target gas flow rate 370 of the gas pipeline based on an initial gas flow rate 350 of the gas pipeline to be adjusted and the flow rate adjustment amplitude 360. The target gas flow rate may be used as the target operating parameters of the gas field station.

The initial gas flow rate refers to a gas flow rate before adjusting the flow rate of the gas pipeline and may be determined from real-time operational data of the gas pipeline.

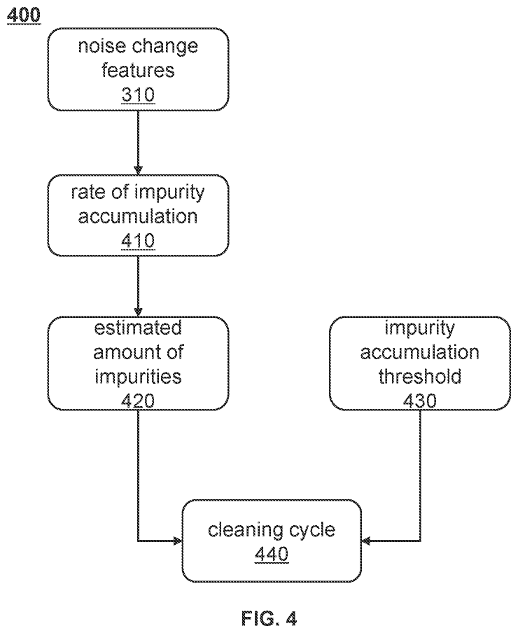

FIG. 4 is an exemplary schematic diagram illustrating a process for determining a cleaning cycle according to some embodiments of the present disclosure. As shown in FIG. 4, a process 400 for determining the cleaning cycle may include the following steps.

In some embodiments, the target operating parameters may also include cleaning parameters of the gas pipeline, and the smart gas safety management platform may also assess a rate of impurity accumulation 410 of the gas pipeline based on the noise change features 310, and determine a cleaning cycle 440 based on the rate of impurity accumulation 410.

The cleaning parameters are those associated with the gas pipeline cleaning process.

In some embodiments, the cleaning parameters may include a cleaning cycle.

The cleaning cycle is a time interval between two previous and subsequent cleanings of the gas pipeline.

The rate of impurity accumulation is data that characterizes a rate of impurity accumulation in the gas pipeline. In some embodiments, the rate of impurity accumulation may be expressed in terms of a rate of increase in the thickness of the impurities within the gas pipeline or may be expressed in terms of a rate of increase in the weight of the impurities within the gas pipeline per unit length.

In some embodiments, the rate of impurity accumulation may be different at different times, for example, the rate of impurity accumulation is slower because an inner wall surface of the gas pipeline is smoother after the gas pipeline is finished being cleaned and the impurities are less likely to attach; the attachment of the impurities causes the inner wall surface of the gas pipeline to become increasingly rough, and the impurities are more likely to attach, and the rate of impurity accumulation is therefore faster.

In some embodiments, the smart gas safety management platform may determine the rate of impurity accumulation in multiple ways.

In some embodiments, the smart gas safety management platform may determine, based on the historical noise change features and the historical gas flow rate, the rate of impurity accumulation corresponding to the current noise change features and the target gas flow rate by vector matching. For example, the smart gas safety management platform may construct at least one reference feature vector based on the historical noise change features corresponding to at least one first historical time period and the historical gas flow rate, and determine, based on the historical data, reference noise change features and a rate of reference impurity accumulation of a second historical time period corresponding to each reference feature vector, the second historical time period is later than the first historical time period. A vector to be matched, based on the current noise change features and the target gas flow rate, is constructed, a target feature vector with the closest vector distance is determined based on the matching of the vector to be matched with the at least one reference feature vector. A rate of impurity accumulation corresponding to the current noise change features and the target gas flow rate based on the reference noise change features and the rate of reference impurity accumulation corresponding to the target feature vectors is determined.

Since more impurities accumulate in the gas pipeline at the same gas flow rate, the greater the noise generated by the gas pipeline, the impurity accumulation may be judged by the noise change features, and the faster the target gas flow rate is, the less likely the impurities are to adhere. The faster the target gas flow rate is, the slower the rate of impurity accumulation is.

In some embodiments, the smart gas safety management platform may assess the rate of impurity accumulation in the gas pipeline based on the noise change features, the pipeline features, and the target gas flow rate. For more information on determining the rate of impurity accumulation, please refer to FIG. 5 and its related description.

In some embodiments, the smart gas safety management platform may determine the cleaning cycle in multiple ways. For example, the smart gas safety management platform may, based on the rate of impurity accumulation, calculate a time required for the accumulation of impurities to reach an impurity accumulation threshold from the moment when the gas pipeline has just been cleaned out, and determine that length of time as the cleaning cycle. The impurity accumulation threshold may be preset based on a priori experience.

In some embodiments, the smart gas service platform may calculate an estimated amount of impurities 420 for a target time based on the rate of impurity accumulation 410, and determine the cleaning cycle 440 based on the relationship between the estimated amount of impurities 420 and the impurity accumulation threshold 430.

The target time refers to a start time of a low gas consumption period, such as 1:00 a.m. and so on. The low gas consumption period refers to a time period when the gas user consumes less gas, and the low gas consumption period is different for different gas users. For example, if the gas consumption of a residential gas customer decreases significantly after 1:00 a.m., the low gas consumption period starts at 1:00 a.m., and if the gas consumption of a commercial gas customer decreases significantly after 6:00 p.m., the low gas consumption period starts at 6:00 p.m.

In some embodiments, there may be multiple target times, and the smart gas safety management platform may determine a time period with significantly reduced gas consumption based on the gas usage data of the gas users, and designate the start time of the low peak gas consumption period as the target time.

In some embodiments, when cleaning the gas pipeline, it is necessary to shut down the corresponding gas pipeline. Therefore, selecting the target time as the cleaning time for the gas pipeline may minimize the impact on gas supply to the gas pipeline.

The estimated amount of impurities refer to a cumulative amount of impurities inside the gas pipeline estimated in advance.

In some embodiments, the smart gas safety management platform may calculate the estimated amount of impurities at the target time from the end of the previous gas pipeline cleaning, and there are multiple periods of time between the end of the previous cleaning and the target time. The smart gas safety management platform may determine the accumulation amount of impurities in each period by using the respective rate of impurity accumulation in each period and the corresponding length of time. The accumulation amounts of impurities in different periods may be summed up to obtain the estimated amount of impurities at the target time.

For example, there are time periods A and B between the end of the previous gas pipeline cleaning and the target time. The rate of impurity accumulation in the time period A is A₁, and the duration of the time period A is 8 hours. Therefore, the amount of impurity accumulation in the time period A is 8×A₁. Similarly, the amount of impurity accumulation in the time period B may be 8×B1. By summing up the amounts of impurity accumulation in both time periods, the estimated amount of impurities at the target time may be obtained as 8×(A₁+B₁).

In some embodiments, the smart gas safety management platform may sequentially determine the relationship between each estimated amount of impurities and the impurity accumulation threshold based on the order of the estimated amount of impurities corresponding to at least one target time. If a first estimated amount of impurities greater than the impurity accumulation threshold is found, the smart gas safety management platform may determine the target time corresponding to that estimated amount of impurities. The duration obtained by subtracting the previous target time from the previous time point of the end of the gas pipeline cleaning is used as the cleaning cycle. For more information on the impurity accumulation threshold, please refer to following content.

For example, if the previous gas pipeline cleaning ended at 1:00 a.m. on the same day, and the target time at which the first estimated amount of impurities exceeds the impurity accumulation threshold is 4:00 p.m. on the next day, then the difference between the target time before 4:00 p.m. on the next day (e.g., 12 a.m. of the next day) and the end time of the previous gas pipeline cleaning is 11 hours, and the cleaning cycle is 11 hours.

In some embodiments, determining the cleaning cycle based on the previous target time of the current target time may prevent impurity accumulation from exceeding the impurity accumulation threshold, and the target time refers to a time at which the estimated amount of impurities exceeds the impurity accumulation threshold.

The impurity accumulation threshold refers to an impurity accumulation threshold in the gas pipeline. For example, the impurity accumulation threshold may be a maximum value of impurity accumulation that does not affect the operation of the gas pipeline.

In some embodiments, the smart gas safety management platform may determine the impurity accumulation threshold based on the target gas flow rate, and the faster the target gas flow rate is, the smaller the impurity accumulation threshold is. When the target gas flow rate is faster, there will be more impurities in the gas pipeline, resulting in greater noise. Therefore, reducing the impurity accumulation threshold may ensure that the impurities in the gas pipeline are accumulated below a smaller value, thereby reducing the generated noise.

In some embodiments, the cleaning parameters may also include a cleaning intensity. The smart gas safety management platform may predict the pipeline features of the gas pipeline based on the cleaning cycle, and determine the cleaning intensity based on the pipeline features through a preset table.

The cleaning intensity is data that characterizes the extent to which impurities are removed from the gas pipeline. For example, the cleaning intensity may include a regular cleaning or a light cleaning. The regular cleaning refers to a thorough removal of impurities from the gas pipeline, but it may cause damage to the inner wall surface of the pipeline. The light cleaning means removing the impurities from the gas pipeline without contacting the inner wall surface of the pipeline.

The pipeline features are data that characterize the roughness of the inner wall of the gas pipeline. For more information on the pipeline features of the predicted gas pipeline, please refer to FIG. 5 and its related description.

In some embodiments, the smart gas safety management platform may determine the cleaning intensity based on the pipeline features using the preset table.

In some embodiments, the preset table may be determined based on the historical data. The preset table may include at least one reference data set, each data set including a first pipeline feature, an historical cleaning intensity, a second pipeline feature, and a pipeline pressure stability. The first pipeline feature refers to roughness data of the inner wall of the gas pipeline in the historical data when no cleaning is performed. The second pipeline feature refers to roughness data of the inner wall of the gas pipeline after the cleaning based on the historical cleaning intensity in the historical data.

The pipeline pressure stability may be determined based on the change in pressure within the gas pipeline after cleaning. For example, a small change in pressure in the gas pipeline after cleaning indicates good pipeline pressure stability.

In some embodiments, the smart gas safety management platform may query the preset table based on the pipeline features to determine at least one first pipeline feature that is closest to the given pipeline features; take a reference data group in which the at least one first pipeline feature is located as a candidate data set; screen a candidate data set based on the second pipeline feature and the pipeline pressure stability, and select the candidate data set with strong pipeline pressure stability and smaller roughness corresponding to the second pipeline feature as a target data set; and determine a current cleaning intensity based on the historical cleaning intensity in the target data set.

During the cleaning process of the gas pipeline, excessive or insufficient cleaning intensity may both affect the pressure stability within the pipeline. The excessive cleaning intensity may damage the pipeline, and the pressure inside the pipeline is affected when the gas passes through, which may generate noise; the insufficient cleaning intensity may not achieve the cleaning impact, and the impurities left in the pipeline may also affect the gas delivery, thus generating noise.

In some embodiments of the present disclosure, a more reasonable cleaning intensity may be obtained by determining the cleaning intensity based on the predicted pipeline features using the preset table, considering the impact of cleaning intensity on the roughness of the inner wall of the gas pipeline, and the impact of the wall roughness on the pipeline pressure stability.

In some embodiments of the present disclosure, a more suitable cleaning cycle may be determined by calculating the estimated amount of impurities at the target time based on the rate of impurity accumulation and determining the cleaning cycle based on the relationship between the estimated amount of impurities and the impurity accumulation threshold. This may reduce the impact of cleaning the gas pipeline on gas supply and prevent the excessive impurity accumulation in the pipeline.

In some embodiments of the present disclosure, the rate of impurity accumulation in the gas pipeline may be assessed based on the noise change features, and the cleaning period may be determined based on the rate of impurity accumulation. The cleaning time of the gas pipeline may be determined based on the actual situation of the gas pipeline without stopping the gas supply, thereby timely controlling the noise generation of the gas pipeline and reducing the impact of noise on the gas users.

FIG. 5 is a schematic diagram illustrating a process for assessing a rate of impurity accumulation in a gas pipeline according to some embodiments of the present disclosure. As shown in FIG. 5, a process 500 for assessing of the rate of impurity accumulation may include the following.

In some embodiments, the smart gas safety management platform may obtain historical cleaning data 510 of the gas pipeline, assess pipeline features 540 of the gas pipeline based on the historical cleaning data 510, and assess the rate of impurity accumulation 410 of the gas pipeline based on the noise change features 310, the pipeline features 540, and the target gas flow rate 370.

For more information on the noise change features and the target gas flow rate, please refer to FIG. 2 and its related description.

The historical cleaning data refers to data related to the cleaning of the gas pipeline in the historical data. In some embodiments, the smart gas safety management platform may obtain the historical cleaning data from the smart gas data center.

The pipeline features are data that characterize the roughness of the inner wall of the gas pipeline.

In some embodiments, the smart gas safety management platform may extract a cleaning time interval 511 and an amount of impurity cleaning 512 from the historical cleaning data 510, and based on the cleaning time interval 511 and the amount of impurity cleaning 512, determine historical change data 530 of the gas pipeline, and based on the historical change data 530, determine the pipeline features 540 of the gas pipeline.

The cleaning time interval refers to a cleaning period of the two consecutive cleanings of the gas pipeline in the historical data.

The amount of impurity cleaning refers to an amount of impurities cleaned during each cleaning of the gas pipeline in the historical data. In some embodiments, the amount of impurity cleaning may be a sequence composed of a single amount of impurities cleaned.

The historical change data refers to data that characterizes the changes in the roughness of the inner wall of the gas pipeline. In some embodiments, the historical change data may be a sequence composed of roughness change data.

In some embodiments, based on the increase in the amount of impurity cleaning for each consecutive pair of the gas pipeline cleanings, the smart gas safety management platform may determine, through the correspondence between the amount of impurity cleaning increase and a roughness increase, the roughness increase for each consecutive pair of the gas pipeline cleanings, and form a data sequence of multiple roughness increases to obtain the historical change data.

In some embodiments, the correspondence between the increase in the amount of impurity cleaning and the roughness increase may be obtained by fitting the historical data, where the greater the increase in the amount of impurity cleaning is, the greater the roughness increase is.

In some embodiments, the historical change data may characterize the change in the roughness increase, and the smart gas safety management platform may predict a subsequent roughness increase based on the historical change data.

In some embodiments, the smart gas safety management platform may add the pipeline features measured after the previous pipeline cleaning to the roughness increase, and the result obtained is determined to be the current pipeline feature of the gas pipeline. The roughness increase is the roughness increase obtained by the smart gas safety management platform based on an estimate of the historical change data.

In some embodiments of the present disclosure, determining the historical change data of the gas pipeline based on the cleaning time interval and the amount of impurity cleaning, and determining the pipeline feature of the gas pipeline based on the historical change data, a current roughness of the inner wall of the gas pipeline may be obtained. Since an increase in the roughness of the inner wall of the gas pipeline leads to an increase in the rate of impurity accumulation, determining the current roughness of the inner wall of the gas pipeline is beneficial for subsequently determining the rate of impurity accumulation.

In some embodiments, the smart gas safety management platform may assess the rate of impurity accumulation 410 of the gas pipeline via an impurity assessment model 550 based on the noise change feature 310, the pipeline features 540, and the target gas flow rate 370.

The impurity assessment model may refer to a model for assessing the rate of impurity accumulation in the gas pipeline, and in some embodiments, the impurity assessment model may be a machine learning model. For example, the impurity assessment model may include a convolutional neural networks (CNN) model, a neural networks (NN) model, or any one or combination of other customized model structures, etc.

In some embodiments, inputs to the impurity assessment model may include the noise change features, the pipeline features, and the target gas flow rate, and outputs of the impurity assessment model may include the rate of impurity accumulation. For more information on the noise change features, the target gas flow rate, please refer to FIG. 2 and its related description. For more information on the pipeline features, please refer to the preceding description.

In some embodiments, the impurity assessment model may be trained based on a large number of third training samples with third labels. The third training samples may include sample noise change features, sample pipeline features, and sample target gas flow rates, and the third labels may be actual rates of impurity accumulation. In some embodiments, the first training sample may be obtained based on the historical data.

In some embodiments, the smart gas safety management platform may determine the actual rates of impurity accumulation as the third labels after supplying gas to the gas pipeline corresponding to the third training samples.

In some embodiments, the impurity assessment model may be trained by: inputting a plurality of third training samples with third labels into an initial impurity assessment model, constructing a loss function through the third labels and prediction results of the initial impurity assessment model, updating the initial impurity assessment model based on iterations of the loss function, and completing the training of the impurity assessment model when the loss function of the impurity assessment model meets a preset condition. The preset condition may be a loss function convergence, a number of iterations reaching a set value, etc.

In some embodiments of the present disclosure, assessing the rate of impurity accumulation of the gas pipeline by the impurity assessment model allows the rate of impurity accumulation of the gas pipeline to be obtained quickly and accurately, saving labor and time costs.

In some embodiments of the present disclosure, assessing the rate of impurity accumulation in the gas pipeline based on the noise change features, the pipeline features, and the target gas flow rate may be used to obtain an accurate rate of impurity accumulation based on the actual use of the pipeline, which may lead to the determination of a reasonable cleaning cycle.

Some embodiments of the present disclosure also disclose a computer-readable storage medium, the storage medium stores computer instructions, and when the computer instructions are executed by a processor, the method for determining an allocation scheme of accident rescue resource in a smart city is implemented.

The term “one embodiment” or “an embodiment” or “an alternative embodiment” mentioned multiple times at different positions in this disclosure does not necessarily refer to the same embodiment. Additionally, certain features, structures, or features in one or more embodiments of this disclosure may be suitably combined.

Similarly, it should be understood that for the sake of simplicity and to aid in the understanding of one or more embodiments of the invention, the descriptions of embodiments in this disclosure at times may combine multiple features into a single embodiment, accompanying drawings, or their descriptions. However, the use of such disclosure does not imply that the claimed subject matter requires more features than what is stated in the claims. In fact, the features of the embodiments may be fewer than all the features disclosed in a particular embodiment described above.

What is claimed is:

1. A method for noise control based on a smart gas platform, wherein the method is executed by a smart gas safety management platform of an Internet of Things (IoT) system for noise control based on the smart gas platform, the method comprising:
obtaining noise data of a gas field station through a sound sensor, the sound sensor being arranged at least one monitoring position of the gas field station, and any one monitoring position having a corresponding monitoring period;
determining noise change features of the at least one monitoring position based on the noise data; and
determining target operating parameters of the gas field station based on the noise change features, the target operating parameters including a target gas flow rate of a gas pipeline in the gas field station.

2. The method of claim 1, wherein the determining target operating parameters of the gas field station based on the noise change features includes:
in response to the noise change features of a monitoring position meeting a first preset condition, determining the monitoring position as a target monitoring position, the first preset condition including a noise change threshold;
determining a gas pipeline to be adjusted based on noise propagation features between the target monitoring position and the gas pipeline;
determining a flow rate adjustment amplitude of the gas pipeline to be adjusted based on the noise change feature, the noise change threshold, the noise propagation feature, and a noise propagation range; and
determining the target gas flow rate of the gas pipeline based on an initial gas flow rate of the gas pipeline to be adjusted and the flow rate adjustment amplitude.

3. The method of claim 2, wherein the noise change features include intensity change features and frequency change features; and
an impact of the intensity change features on the flow rate adjustment amplitude is greater than an impact of the frequency change features.

4. The method of claim 3, wherein the determining the flow rate adjustment amplitude further includes:
constructing a station feature map based on pipeline data of a target gas field station, pressure regulating equipment data, the initial gas flow rate, and the flow rate adjustment amplitude;
predicting estimated change features corresponding to the flow rate adjustment amplitude by a noise prediction model based on the station feature map; and
determining a preferred adjustment amplitude by performing a plurality of rounds of iterative updates on the flow rate adjustment amplitude based on the estimated change features.

5. The method of claim 4, wherein each round of the iterative updates includes:
determining an output pressure of the gas pipeline after adjustment based on the flow rate adjustment amplitude by processing the flow rate adjustment amplitude through a pressure judgment model;
in response to the output pressure meeting a preset pressure condition, determining the estimated change features through the noise prediction model; and
in response to the output pressure not meeting the preset pressure condition, re-determining the flow rate adjustment amplitude.

6. The method of claim 1, wherein the target operating parameters also include cleaning parameters of the gas pipeline, the cleaning parameters including at least a cleaning cycle;
the method also includes:
assessing a rate of impurity accumulation of the gas pipeline based on the noise change features; and
determining the cleaning cycle based on the rate of impurity accumulation.

7. The method of claim 6, wherein the determining the cleaning cycle based on the rate of impurity accumulation includes
determining an estimated amount of impurities at a target time based on the rate of impurity accumulation; and
determining the cleaning cycle based on the estimated amount of impurities and an impurity accumulation threshold, and the impurity accumulation threshold being determined based on a target gas flow rate.

8. The method of claim 6, wherein the assessing a rate of impurity accumulation of the gas pipeline based on the noise change features includes:
obtaining historical cleaning data of the gas pipeline;
assessing pipeline features of the gas pipeline based on the historical cleaning data; and
assessing the rate of impurity accumulation of the gas pipeline based on the noise change features, the pipeline features, and the target gas flow rate.

9. The method of claim 8, wherein the assessing pipeline features of the gas pipeline based on the historical cleaning data includes:
extracting a cleaning time interval and an amount of impurity cleaning from the historical cleaning data; and determining historical change data of the gas pipeline based on the cleaning time interval and the amount of impurity cleaning; and
determining the pipeline features of the gas pipeline based on the historical change data.

10. An Internet of Things (IoT) system for noise control based on a smart gas platform, wherein the IoT system includes a smart gas user platform, a smart gas service platform, a smart gas safety management platform, a smart gas pipeline network equipment sensor network platform, and a smart gas pipeline network equipment object platform;
the smart gas safety management platform being configured to:
obtain noise data of a gas field station through a sound sensor, the sound sensor being arranged at least one monitoring position of the gas field station, and any one monitoring position having a corresponding monitoring period;
determine noise change features of the at least one monitoring position based on the noise data; and
determine target operating parameters of the gas field station based on the noise change features, the target operating parameters including a target gas flow rate of a gas pipeline in the gas field station.

11. The IoT system of claim 10, wherein the smart gas safety management platform includes a smart gas pipeline network safety management sub-platform and a smart gas data center;
the smart gas safety management platform interacts with the smart gas service platform and the smart gas pipeline network equipment sensor network platform through the smart gas data center.

12. The IoT system of claim 11, wherein the smart gas safety management platform is further configured to:
in response to the noise change features of a monitoring position meeting a first preset condition, determine the monitoring position as a target monitoring position, the first preset condition including a noise change threshold;
determine a gas pipeline to be adjusted based on noise propagation features between the target monitoring position and the gas pipeline;
determine a flow rate adjustment amplitude of the gas pipeline to be adjusted based on the noise change features, the noise change threshold, the noise propagation features, and a noise propagation range; and
determine the target gas flow rate of the gas pipeline based on an initial gas flow rate of the gas pipeline to be adjusted and the flow rate adjustment amplitude.

13. The IoT system of claim 12, wherein the noise change features include intensity change features and frequency change features; and
an impact of the intensity change features on the flow rate adjustment amplitude is greater than an impact of the frequency change features.

14. The IoT system of claim 13, wherein the smart gas safety management platform is further configured to:
construct a station feature map based on pipeline data of a target gas field station, pressure regulating equipment data, the initial gas flow rate, and the flow rate adjustment amplitude;
predict estimated change features corresponding to the flow rate adjustment amplitude by a noise prediction model, based on the station feature map; and
determine a preferred adjustment amplitude by perform a plurality of rounds of iterative updates on the flow rate adjustment amplitude based on the estimated change features.

15. The IoT system of claim 14, wherein the smart gas safety management platform is further configured to:
determine an output pressure of the gas pipeline after adjustment based on the flow rate adjustment amplitude by processing the flow rate adjustment amplitude through a pressure judgment model;
in response to the output pressure meeting a preset pressure condition, determine the estimated change features through the noise prediction model; and
in response to the output pressure not meeting the preset pressure condition, re-determine the flow rate adjustment amplitude.

16. The IoT system of claim 11, wherein the target operating parameters also include cleaning parameters of the gas pipeline, the cleaning parameters including at least a cleaning cycle;
the smart gas safety management platform is also configured to:
assess a rate of impurity accumulation of the gas pipeline based on the noise change features; and
determine the cleaning cycle based on the rate of impurity accumulation.

17. The IoT system of claim 16, wherein the smart gas safety management platform is further configured to:
determine an estimated amount of impurities at a target time based on the rate of impurity accumulation; and
determine the cleaning cycle based on the estimated amount of impurities and an impurity accumulation threshold, and the impurity accumulation threshold being determined based on a target gas flow rate.

18. The IoT system of claim 16, wherein the smart gas safety management platform is further configured to:
obtain historical cleaning data of the gas pipeline;
assessing pipeline features of the gas pipeline based on the historical cleaning data; and
assessing the rate of impurity accumulation of the gas pipeline based on the noise change features, the pipeline features, and the target gas flow rate.

19. The IoT system of claim 18, wherein the smart gas safety management platform is further configured to:
extract a cleaning time interval and an amount of impurity cleaning from the historical cleaning data; determine historical change data of the gas pipeline, based on the cleaning time interval and the amount of impurity cleaning; and
determine the pipeline features of the gas pipeline, based on the historical change data.

20. A non-transitory computer-readable storage medium, comprising a set of instructions, wherein when a computer reads the computer instructions in the storage medium, the method for noise control based on a smart gas platform of claim 1 is implemented.
